(19) United States
(12) Patent Application Publication
(10) Pub. No.: US 2012/0127301 A1
(43) Pub. Date: May 24, 2012

(54) ADAPTIVE SPECTRAL IMAGING BY USING AN IMAGING ASSEMBLY WITH TUNABLE SPECTRAL SENSITIVITIES

(75) Inventor: Francisco Imai, Mountain View, CA (US)

(73) Assignee: CANON KABUSHIKI KAISHA, Tokyo (JP)

(21) Appl. No.: 12/949,592

(22) Filed: Nov. 18, 2010

(51) Int. Cl. H04N 7/18

(52) U.S. Cl. 348/135; 348/E07.085

(57) ABSTRACT

Image capture using an imaging assembly having a spectral response which is tunable in accordance with a capture parameter. The capture parameter has high spectral dimensionality. A sample image of a scene is captured and the sample image is analyzed to identify multiple different regions in the scene. Each such region shares similar spectral content that is dissimilar from spectral content in other regions of the scene. Spectral bands for each region of the multiple different regions are determined so as to increase spectral differentiation for spectral content in each such region. A spectral mask is constructed for application to the imaging assembly. The spectral mask is constructed from the spectral bands for the multiple different regions. The spectral mask is applied as the capture parameter to the imaging assembly, and a spectral image of the scene is captured and stored.

### FIELD

The present disclosure relates to spectral image capture.

### BACKGROUND

Spectral imaging systems, having more spectral bands than the typical three bands in the human eye, enable recognition of the ground-truth of materials in an imaged scene, by identifying the spectral fingerprint that is unique to each material.

### SUMMARY

Recently, imaging assemblies have been developed in which the imaging assemblies have a tunable spectral response. Two examples of such imaging assemblies are described here. In the first example of imaging assemblies which have a tunable spectral response, there are imaging assemblies where the image sensor itself has a tunable spectral response. For instance, there is an image sensor described in “The Transverse Field Detector: A Novel Color Sensitive CMOS Device”, Zaraga, IEEE Electron Device Letters 29, 1306-1308 (2008), “Design and Realization of a Novel Pixel Sensor for Color Imaging Applications in CMOS 90 NM Technology”, Langfelder, Electronics and Information Department, Politecnico di Milano, via Ponzio 34/5 20133, Milano, Italy, 143-146 (2010), and U.S. Patent Publication No. 2010/0044822, the contents of which are incorporated herein by reference. These documents describe a transverse field detector (TFD) which has a tunable spectral responsivity that can be adjusted by application of bias voltages to control electrodes. Each pixel outputs signals for a red-like channel, a green-like channel, and a blue-like channel.

In particular, in such a three channel TFD, symmetric biasing is applied, such that related pairs of control electrodes each receive the same bias voltages. FIG. 1 is a schematic view of a cross section of a TFD three channel pixel. As shown in FIG. 1, symmetric biasing is applied, such that control electrodes #2A and #2B each receive the same bias voltage, and control electrodes #1A and #1B each receive the same bias voltage.

A TFD with more than three channels can be provided by applying an asymmetric biasing to a symmetric TFD pixel and increasing the number of acquisition spectral in the same pixel area. For example, asymmetric biasing could be applied to the TFD pixel shown in FIG. 1, such that control electrodes #2A and #2B each receive a different bias voltage, and control electrodes #1A and #1B each receive a different bias voltage. Thus, by applying asymmetric biasing, each of the five electrodes of the TFD pixel could receive a different bias voltage, thereby providing for five channels that can each be tuned to different spectral sensitivities.

In some of these image sensors, the spectral responsivity is tunable globally, meaning that all pixels in the image sensor are tuned globally to the same spectral responsivity.

In some others of these image sensors, the spectral responsivity is tunable on a pixel by pixel basis or a region-by-region basis. Bias voltages are applied in a grid-like spatial mask, such that the spectral responsivity of each pixel is tunable individually of other pixels in the image sensor, or such that the spectral responsivity of each region comprising multiple pixels is tunable individually of other regions in the image sensor.

In the second example of imaging assemblies which have a tunable spectral response, there are imaging assemblies where the image sensor is preceded by a color filter array (CFA), and it is the color filter array that has a tunable spectral response. In the first example described above, because the image sensor itself has a tunable spectral response, it might be customary to omit a preceding color filter array, since the inclusion of any filter necessarily would decrease the signal-to-noise ratio by filtering the amount of light incident on the image sensor. In contrast, in this second example, the spectral responsivity of the image sensor is not necessarily tunable, but the spectral responsivity of a preceding color filter array is. For instance, there is a tunable color filter array described in U.S. Pat. No. 6,466,961 by Miller, “Methods for Adaptive Spectral, Spatial and Temporal Sensing for Imaging Applications”, the content of which is incorporated herein by reference. This document describes an imaging assembly comprising a color filter array which precedes an image sensor whose spectral responsivity is constant, but in which the color filter array itself has a tunable spectral responsivity that can be adjusted by application of bias voltages to control electrodes. Each array element thus filters light incident on corresponding pixels of the image sensor, and the image sensor thereafter outputs signals from which a red-like channel, a green-like channel, and a blue-like channel, can all be derived for each pixel. In the case of a color filter array with temporal sensing, the channels for each pixel may be output sequentially, one after the other. In the case of a color filter array with spatial sensing, the channels for each pixel may be output simultaneously or nearly so, although demosaicing might be required depending on the geometry of the color filter array.

A spatial mosaic can be constructed using tunable color filters on top of individual imaging sensors. A Bayer-type mosaic provides color filters tuned to provide three channels distributed spatially. The number of channels can be increased beyond three by tuning color filters to provide four, five or more channels distributed spatially. There is a trade-off between spectral resolution, which is determined by the number of channels, and spatial resolution. However, by increasing the number of pixels of an image sensor, the visual effect of loss in spatial resolution can be minimized. An increased complexity of the spatial mosaic typically requires more complex demosaicing procedures as well as larger spatial filters for demosaicing.

In some of these color filter arrays, the spectral response is tunable globally, resulting in a situation where corresponding channels for all pixels in the image sensor are tuned globally to the same spectral responsivity.

In some others of these color filter arrays, the spectral responsivity is tunable on a pixel by pixel basis or a region-by-region basis. Bias voltages are applied in a grid-like spatial mask, such that the spectral responsivity for each pixel is tunable individually of other pixels, or such that the spectral responsivity for each region comprising multiple pixels is tunable individually of other regions.

According to an aspect of the disclosure herein, image capture is provided using an image capture device which includes an imaging assembly having a spectral response which is tunable in accordance with a capture parameter. A default capture parameter is applied to the imaging assembly. The default capture parameter has high spectral dimensionality. A sample image of a scene is captured and the sample image is analyzed to identify multiple different regions in the scene. Each such region shares similar spectral content that is dissimilar from spectral content in other regions of the scene. Spectral bands for each region of the multiple different regions are determined. The spectral bands are determined so as to increase spectral differentiation for spectral content in each such region. A spectral mask is constructed for application to the imaging assembly. The spectral mask is constructed from the spectral bands for the multiple different regions. The spectral mask is applied as the capture parameter to the imaging assembly, and a spectral image of the scene is captured and stored.

By virtue of the foregoing arrangement, spectral differentiation can be increased for spectral content in each of multiple different regions, as opposed to increasing spectral differentiation for a single region or increasing spectral differentiation globally for the entire scene.

In another example embodiment described herein, the default capture parameter has spectral dimensionality of five or more.

In another example embodiment described herein, the default capture parameter has sensitivities centered in wavelengths which divide the visible spectrum of light with substantially equal levels of sensitivity for each dimension.

In another example embodiment described herein, the default capture parameter has spectral dimensionality of five (5) with sensitivities centered in wavelengths which divide the visible spectrum of light with substantially equal levels of sensitivity each dimension.

In another example embodiment described herein, the spectral mask has a spectral dimensionality equal to that of the default capture parameter. In yet another example embodiment, the spectral mask has a spectral dimensionality different from that of the default capture parameter.

In another example embodiment described herein, the analyzing involves accessing a look-up table (LUT) which maps between spectral signature categories and the high spectral dimensionality of the default capture parameter. For each pixel of the imaging assembly, the LUT is used to map from the high spectral dimensionality of the default capture parameter to a corresponding spectral signature category, wherein a threshold tolerance is applied to accommodate variability of spectral curves in one spectral signature category as well as effects of imaging system noise. Contiguous pixels with similar spectral signature categories are clustered into the same region.

In another example embodiment described herein, the imaging assembly comprises an image sensor which has a tunable spectral response.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is a schematic view of a cross section of a TFD pixel.

FIG. 2 is a block diagram showing an example embodiment of a multi-spectral digital camera.

FIG. 2A is a view for explaining the architecture of modules according to an example embodiment.

FIGS. 3 and 4 are views showing external appearance of an example embodiment.

FIG. 5 is a flow diagram for explaining an example embodiment of a spectral image capture of a scene.

FIG. 6 is a conceptual illustration of color channels of each pixel in the imaging sensor with tunable color sensitivities in an example embodiment.

FIG. 7 is an example of a capture parameter for spectral sensitivities of pixels of the image sensor.

FIG. 8 shows an adaptive method to determine initial state pixel-based spatial electronic voltage mask.

FIG. 9 illustrates an example 3×3 pixel group of the captured spectral image.

FIG. 10 illustrates spectral reflectance for a dark blue region of the captured spectral image.

FIG. 11 is a block diagram showing an example embodiment of a multi-spectral digital camera.

FIG. 12 is a flow diagram for explaining an example embodiment of a spectral image capture of a scene.

### DETAILED DESCRIPTION

In the following example embodiments, there is described a multi-spectral digital camera which may be a digital still camera or a digital video camera. It is understood, however, that the following description encompasses arbitrary arrangements which can incorporate or utilize such imaging assemblies having a spectral response which is tunable in accordance with a capture parameter, for instance, a data processing apparatus having an image sensing function (e.g., a personal computer) or a portable terminal having an image sensing function (e.g., a mobile telephone).

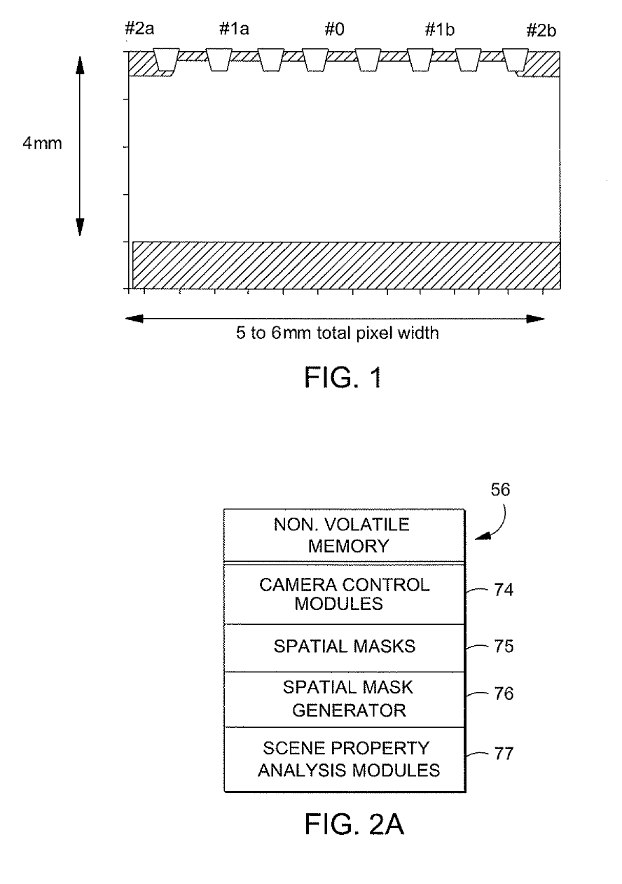

### <FIGS. 1 to 10>

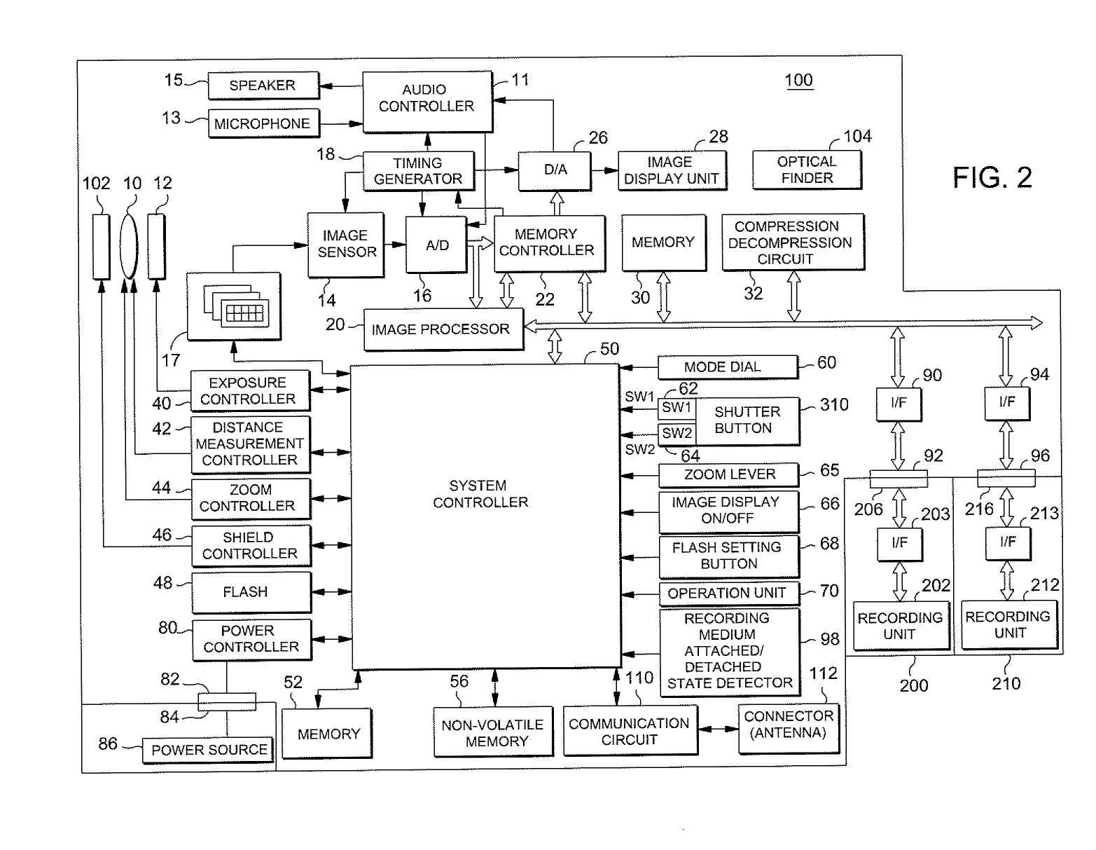

FIG. 2 is a block diagram showing an example of the arrangement of the multi-spectral digital camera 100 as an image capturing device according to this embodiment. Referring to FIG. 2, reference numeral 10 denotes an imaging lens; 12, a shutter having an aperture function; and 14, an image sensor which has a spectral response which is tunable in accordance with a capture parameter, which converts an optical image into an electrical signal. Reference numeral 16 denotes an A/D converter which converts an analog signal into a digital signal. The A/D converter 16 is used when an analog signal output from the image sensor 14 is converted into a digital signal and when an analog signal output from an audio controller 11 is converted into a digital signal. Reference numeral 102 denotes a shield, or barrier, which covers the image sensor including the lens 10 of the digital camera 100 to prevent an image capturing system including the lens 10, shutter 12, and image sensor 14 from being contaminated or damaged.

In FIG. 2, an imaging assembly is comprised of image sensor 14 and associated optics, such that in some embodiments the imaging assembly is comprised of image sensor 14 and lens 10.

The optical system 10 may be of a zoom lens, thereby providing an optical zoom function. The optical zoom function is realized by driving a magnification-variable lens of the optical system 10 using a driving mechanism of the optical system 10 or a driving mechanism provided on the main unit of the digital camera 100.

A light beam (light beam incident upon the angle of view of the lens) from an object in a scene that goes through the optical system (image sensing lens) 10 passes through an opening of a shutter 12 having a diaphragm function, and forms an optical image of the object on the image sensing surface of the image sensor 14. The image sensor 14 converts the optical image to analog image signals and outputs the signals to an A/D converter 16. The A/D converter 16 converts the analog image signals to digital image signals (image data). The image sensor 14 and the A/D converter 16 are controlled by clock signals and control signals provided by a timing generator 18. The timing generator 18 is controlled by a memory controller 22 and a system controller 50.

Image sensor 14 is a multi-spectral image sensor which has a spectral response which is tunable in accordance with a capture parameter 17. For each pixel, image sensor 14 outputs five or more channels of color information, including a red-like channel, a green-yellow-like channel, a green-like channel, a blue-green-like channel, and a blue-like channel. The precise nature of the spectral responsivity of image sensor 14 is controlled via capture parameter 17. In this embodiment, capture parameter 17 may be comprised of multiple spatial masks, with one mask each for each channel of information output by image sensor 14. Thus, in this example, where image sensor 14 outputs five or more channels, capture parameter 17 includes a spatial mask DR for the red-like channel of information, a spatial mask DGY for the green-yellow-like channel of information, a spatial mask DG for the green-like channel of information, a spatial mask DBG for the blue-greem-like channel of information and a spatial mask DB for the blue-like channel of information. Each spatial mask comprises an array of control parameters corresponding to pixels or regions of pixels in image sensor 14. The spectral responsivity of each pixel, or each region of plural pixels, is thus tunable individually and independently of other pixels or regions of pixels.

Image sensor 14 may be comprised of a transverse field detector (TFD) sensor mentioned hereinabove. Spatial masks DR, DGY, DG, DBG and DB may correspond to voltage biases applied to control electrodes of the TFD sensor.

Reference numeral 18 denotes a timing generator, which supplies clock signals and control signals to the image sensor 14, the audio controller 11, the A/D converter 16, and a D/A converter 26. The timing generator 18 is controlled by a memory controller 22 and system controller 50. Reference numeral 20 denotes an image processor, which applies resize processing such as predetermined interpolation and reduction, and color conversion processing to data from the A/D converter 16 or that from the memory controller 22. The image processor 20 executes predetermined arithmetic processing using the captured image data, and the system controller 50 executes exposure control and ranging control based on the obtained arithmetic result.

As a result, TTL (through-the-lens) AF (auto focus) processing, AE (auto exposure) processing, and EF (flash pre-emission) processing are executed. The image processor 20 further executes predetermined arithmetic processing using the captured image data, and also executes TTL AWB (auto white balance) processing based on the obtained arithmetic result. It is understood that in other embodiments, optical finder 104 may be used in combination with the TTL arrangement, or in substitution therefor.

Output data from the A/D converter 16 is written in a memory 30 via the image processor 20 and memory controller 22 or directly via the memory controller 22. The memory 30 stores image data which is captured by the image sensor 14 and is converted into digital data by the A/D converter 16, and image data to be displayed on an image display unit 28. The image display unit 28 may be a liquid crystal screen. Note that the memory 30 is also used to store audio data recorded via a microphone 13, still images, movies, and file headers upon forming image files. Therefore, the memory 30 has a storage capacity large enough to store a predetermined number of still image data, and movie data and audio data for a predetermined period of time.

A compression/decompression unit 32 compresses or decompresses image data by adaptive discrete cosine transform (ADCT) or the like. The compression/decompression unit 32 loads captured image data stored in the memory 30 in response to pressing of the shutter 310 as a trigger, executes the compression processing, and writes the processed data in the memory 30. Also, the compression/decompression unit 32 applies decompression processing to compressed image data loaded from a detachable recording unit 202 or 212, as described below, and writes the processed data in the memory 30. Likewise, image data written in the memory 30 by the compression/decompression unit 32 is converted into a file by the system controller 50, and that file is recorded in the recording unit 202 or 212, as also described below.

The memory 30 also serves as an image display memory (video memory). Reference numeral 26 denotes a D/A converter, which converts image display data stored in the memory 30 into an analog signal, and supplies that analog signal to the image display unit 28. Reference numeral 28 denotes an image display unit, which makes display according to the analog signal from the D/A converter 26 on the liquid crystal screen 28 of an LCD display. In this manner, image data to be displayed written in the memory 30 is displayed by the image display unit 28 via the D/A converter 26.

The exposure controller 40 controls the shutter 12 having a diaphragm function based on the data supplied from the system controller 50. The exposure controller 40 may also have a flash exposure compensation function by linking up with a flash (flash emission device) 48. The flash 48 has an AF auxiliary light projection function and a flash exposure compensation function.

The distance measurement controller 42 controls a focusing lens of the optical system 10 based on the data supplied from the system controller 50. A zoom controller 44 controls zooming of the optical system 10. A shield controller 46 controls the operation of a shield (barrier) 102 to protect the optical system 10.

Reference numeral 13 denotes a microphone. An audio signal output from the microphone 13 is supplied to the A/D converter 16 via the audio controller 11 which includes an amplifier and the like, is converted into a digital signal by the A/D converter 16, and is then stored in the memory 30 by the memory controller 22. On the other hand, audio data is loaded from the memory 30, and is converted into an analog signal by the D/A converter 26. The audio controller 11 drives a speaker 15 according to this analog signal, thus outputting a sound.

A nonvolatile memory 56 is an electrically erasable and recordable memory, and uses, for example, an EEPROM. The nonvolatile memory 56 stores constants, computer-executable programs, and the like for operation of system controller 50. Note that the programs include those for execution of various flowcharts.

In particular, and as shown in FIG. 2A, non-volatile memory 56 is an example of a non-transitory computer-readable memory medium, having stored thereon camera control modules 74 as described herein. Also stored thereon are pre-designated capture parameters for application to image sensor 14 so as to control spectral responsivity of the image sensor. In this embodiment, the capture parameters are comprised of spatial masks 75 so as to permit pixel-by-pixel or region-by-region control of spectral responsivity, independently of other pixels or regions. A spatial mask generator 76 generates masks, such as by providing one of pre-designated masks 75 or by deriving a new mask. The derived mask may be based on a comparison of scene properties as provided by scene property analysis module 77.

Reference numeral 50 denotes a system controller, which controls the entire digital camera 100. The system controller 50 executes programs recorded in the aforementioned nonvolatile memory 56 to implement respective processes to be described later of this embodiment. Reference numeral 52 denotes a system memory which comprises a RAM. On the system memory 52, constants and variables required to operate system controller 50, programs read out from the nonvolatile memory 56, and the like are mapped.

A mode selection switch 60, shutter switch 310, and operation unit 70 form operation means used to input various operation instructions to the system controller 50.

The mode selection switch 60 includes the imaging/playback selection switch, and is used to switch the operation mode of the system controller 50 to one of a still image recording mode, movie recording mode, playback mode, and the like.

The shutter switch 62 is turned on in the middle of operation (half stroke) of the shutter button 310 arranged on the digital camera 100, and generates a first shutter switch signal SW1. Also, the shutter switch 64 is turned on upon completion of operation (full stroke) of the shutterbutton 310, and generates a second shutter switch signal SW2. The system controller 50 starts the operations of the AF (auto focus) processing, AE (auto exposure) processing, AWB (auto white balance) processing, EF (flash pre-emission) processing, and the like in response to the first shutter switch signal SW1. Also, in response to the second shutter switch signal SW2, the system controller 50 starts a series of processing (shooting) including the following: processing to read image signals from the image sensing device 14, convert the image signals into image data by the A/D converter 16, process the image data by the image processor 20, and write the data in the memory 30 through the memory controller 22; and processing to read the image data from the memory 30, compress the image data by the compression/decompression circuit 32, and write the compressed image data in the recording medium 200 or 210.

A zoom operation unit 65 is an operation unit operated by a user for changing the angle of view (zooming magnification or shooting magnification). The operation unit 65 can be configured with, e.g., a slide-type or lever-type operation member, and a switch or a sensor for detecting the operation of the member.

The image display ON/OFF switch 66 sets ON/OFF of the image display unit 28. In shooting an image with the optical finder 104, the display of the image display unit 28 configured with a TFT, an LCD or the like may be turned off to cut the power supply for the purpose of power saving.

The flash setting button 68 sets and changes the flash operation mode. In this embodiment, the settable modes include: auto, flash-on, red-eye reduction auto, and flash-on (red-eye reduction). In the auto mode, flash is automatically emitted in accordance with the lightness of an object. In the flash-on mode, flash is always emitted whenever shooting is performed. In the red-eye reduction auto mode, flash is automatically emitted in accordance with lightness of an object, and in case of flash emission the red-eye reduction lamp is always emitted whenever shooting is performed. In the flash-on (red-eye reduction) mode, the red-eye reduction lamp and flash are always emitted.

The operation unit 70 comprises various buttons, touch panels and so on. More specifically, the operation unit 70 includes a menu button, a set button, a macro selection button, a multi-image reproduction/repaging button, a single-shot/serial shot/self-timer selection button, a forward (+) menu selection button, a backward (−) menu selection button, and the like. Furthermore, the operation unit 70 may include a forward (+) reproduction image search button, a backward (−) reproduction image search button, an image shooting quality selection button, an exposure compensation button, a date/time set button, a compression mode switch and the like.

The compression mode switch is provided for setting or selecting a compression rate in JPEG (Joint Photographic Expert Group) compression, recording in a RAW mode and the like. In the RAW mode, analog image signals outputted by the image sensing device are digitalized (RAW data) as it is and recorded.

Note in the present embodiment, RAW data includes not only the data obtained by performing A/D conversion on the photoelectrically converted data from the image sensing device, but also the data obtained by performing lossless compression on A/D converted data. Moreover, RAW data indicates data maintaining output information from the image sensing device without a loss. For instance, RAW data is A/D converted analog image signals which have not been subjected to white balance processing, color separation processing for separating luminance signals from color signals, or color interpolation processing. Furthermore, RAW data is not limited to digitalized data, but may be of analog image signals obtained from the image sensing device.

According to the present embodiment, the JPEG compression mode includes, e.g., a normal mode and a fine mode. A user of the digital camera 100 can select the normal mode in a case of placing a high value on the data size of a shot image, and can select the fine mode in a case of placing a high value on the quality of a shot image.

In the JPEG compression mode, the compression/decompression circuit 32 reads image data written in the memory 30 to perform compression at a set compression rate, and records the compressed data in, e.g., the recording medium 200.

In the RAW mode, analog image signals are read in units of line in accordance with the pixel arrangement of the color filter of the image sensing device 14, and image data written in the memory 30 through the A/D converter 16 and the memory controller 22 is recorded in the recording medium 200 or 210.

Note that the digital camera 100 according to the present embodiment has a plural-image shooting mode, where plural image data can be recorded in response to a single shooting instruction by a user. Image data recording in this mode includes image data recording typified by an auto bracket mode, where shooting parameters such as white balance and exposure are changed step by step. It also includes recording of image data having different post-shooting image processing contents, for instance, recording of plural image data having different data forms such as recording in a JPEG form or a RAW form, recording of image data having the same form but different compression rates, and recording of image data on which predetermined image processing has been performed and has not been performed.

A power controller 80 comprises a power detection circuit, a DC-DC converter, a switch circuit to select the block to be energized, and the like. The power controller 80 detects the existence/absence of a power source, the type of the power source, and a remaining battery power level, controls the DC-DC converter based on the results of detection and an instruction from the system controller 50, and supplies a necessary voltage to the respective blocks for a necessary period. A power source 86 is a primary battery such as an alkaline battery or a lithium battery, a secondary battery such as an NiCd battery, an NiMH battery or an Li battery, an AC adapter, or the like. The main unit of the digital camera 100 and the power source 86 are connected by connectors 82 and 84 respectively comprised therein.

The recording media 200 and 210 comprise: recording units 202 and 212 that are configured with semiconductor memories, magnetic disks and the like, interfaces 203 and 213 for communication with the digital camera 100, and connectors 206 and 216. The recording media 200 and 210 are connected to the digital camera 100 through connectors 206 and 216 of the media and connectors 92 and 96 of the digital camera 100. To the connectors 92 and 96, interfaces 90 and 94 are connected. The attached/detached state of the recording media 200 and 210 is detected by a recording medium attached/detached state detector 98.

Note that although the digital camera 100 according to the present embodiment comprises two systems of interfaces and connectors for connecting the recording media, a single or plural arbitrary numbers of interfaces and connectors may be provided for connecting a recording medium. Further, interfaces and connectors pursuant to different standards may be provided for each system.

For the interfaces 90 and 94 as well as the connectors 92 and 96, cards in conformity with a standard, e.g., PCMCIA cards, compact flash (CF) (registered trademark) cards and the like, may be used. In this case, connection utilizing various communication cards can realize mutual transfer/reception of image data and control data attached to the image data between the digital camera and other peripheral devices such as computers and printers. The communication cards include, for instance, a LAN card, a modem card, a USB card, an IEEE 1394 card, a P1284 card, an SCSI card, and a communication card for PHS or the like.

The optical finder 104 is configured with, e.g., a TTL finder, which forms an image from the light beam that has gone through the lens 10 utilizing prisms and mirrors. By utilizing the optical finder 104, it is possible to shoot an image without utilizing an electronic view finder function of the image display unit 28. The optical finder 104 includes indicators, which constitute part of the display device 54, for indicating, e.g., a focus state, a camera shake warning, a flash charge state, a shutter speed, an f-stop value, and exposure compensation.

A communication circuit 110 provides various communication functions such as USB, IEEE 1394, P1284, SCSI, modern, LAN, RS232C, and wireless communication. To the communication circuit 110, a connector 112 can be connected for connecting the digital camera 100 to other devices, or an antenna can be provided for wireless communication.

A real-time clock (RTC, not shown) may be provided to measure date and time. The RTC holds an internal power supply unit independently of the power supply controller 80, and continues time measurement even when the power supply unit 86 is OFF. The system controller 50 sets a system timer using a date and time obtained from the RTC at the time of activation, and executes timer control.

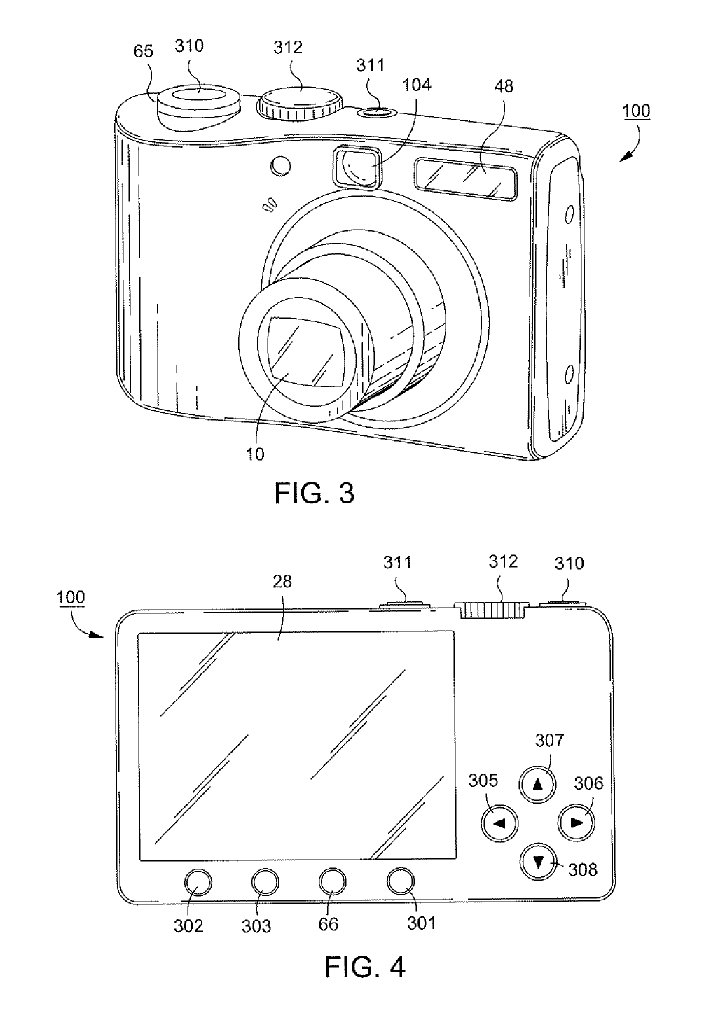

FIGS. 3 and 4 are views showing an example of an external appearance of the digital camera 100. Note in these figures, some components are omitted for description purpose. The aforementioned operation unit 70 comprises, e.g., buttons and switches 301 to 311. A user operates these buttons and switches 301 to 311 for turning ON/OFF the power of the digital camera 100, for setting, changing or confirming the shooting parameters, for confirming the status of the camera, and for confirming shot images.

The power button 311 is provided to start or stop the digital camera 100, or to turn ON/OFF the main power of the digital camera 100. The menu button 302 is provided to display the setting menu such as shooting parameters and operation modes of the digital camera 100, and to display the status of the digital camera 100. The menu has, e.g., a hierarchical structure, and each hierarchy includes selectable items or items whose values are variable.

A delete button 301 is pressed for deleting an image displayed on a playback mode or a shot-image confirmation screen. In the present embodiment, the shot-image confirmation screen (a so-called quick review screen) is provided to display a shot image on the image display unit 28 immediately after shooting for confirming the shot result. Furthermore, the present embodiment is constructed in a way that the shot-image confirmation screen is displayed as long as a user keeps pressing the shutter button 310 after the user instructs shooting by shutter button depression.

An enter button 303 is pressed for selecting a mode or an item. When the enter button 303 is pressed, the system controller 50 sets the mode or item selected at this time. The display ON/OFF button 66 is used for selecting displaying or non-displaying of photograph information regarding the shot image, and for switching the image display unit 28 to be functioned as an electronic view finder.

A left button 305, a right button 306, an up button 307, and a down button 308 may be used for the following purposes, for instance, changing an option (e.g., items, images) selected from plural options, changing an index position that specifies a selected option, and increasing or decreasing numeric values (e.g., correction value, date and time).

Half-stroke of the shutter button 310 instructs the system controller 50 to start, for instance, AF processing, AE processing, AWB processing, EF processing or the like. Full-stroke of the shutter button 310 instructs the system controller 50 to perform shooting.

The zoom operation unit 65 is operated by a user for changing the angle of view (zooming magnification or shooting magnification) as mentioned above.

A recording/playback selection switch 312 is used for switching a recording mode to a playback mode, or switching a playback mode to a recording mode. Note, in place of the above-described operation system, a dial switch may be adopted or other operation systems may be adopted.

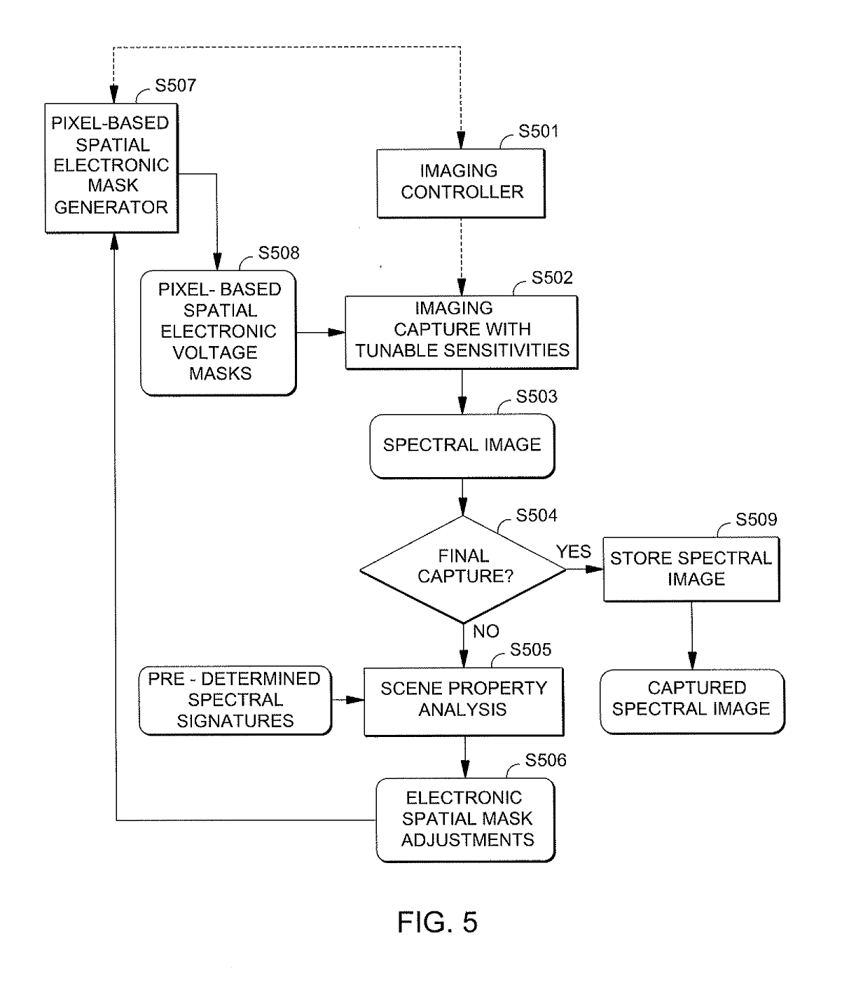

FIG. 5 is a flow diagram for explaining an example embodiment of an image capture of a scene in which spectral selectivity is adjusted on a pixel-by-pixel basis, or a region-by-region basis, for imaging sensors with tunable spectral properties, so as to increase spectral differentiation for spectral content in the scene.

Briefly, according to FIG. 5, a default capture parameter is applied to an imaging assembly having a spectral response which is tunable in accordance with the capture parameter. The default capture parameter has high spectral dimensionality. A sample image of a scene is captured and the sample image is analyzed to identify multiple different regions in the scene. Each such region shares similar spectral content that is dissimilar from spectral content in other regions of the scene. Spectral bands for each region of the multiple different regions are determined. The spectral bands are determined so as to increase spectral differentiation for spectral content in each such region. A spectral mask is constructed for application to the imaging assembly. The spectral mask is constructed from the spectral bands for the multiple different regions. The spectral mask is applied as the capture parameter to the imaging assembly, and a spectral image of the scene is captured and stored.

In step S501, an imaging controller controls spatial electronic mask generator 76 to set-up an initial state for a pixel-by-pixel basis spatial electronic voltage mask that is going to modulate the amplitude and spectral selectivity of an imaging sensor with tunable color sensitivities. The electronic mask can control amplitude and spectra tuning for each pixel. The initial state for the pixel-by-pixel basis spatial mask is given by electronic voltages that has some assumptions about illumination and material properties of the scene and is usually a pre-designated setting determined in advance such as by a calibration procedure that is made in the imaging system assembly line. The default capture parameter includes this initial state for the pixel-by-pixel basis spatial mask. In the example embodiment, this capture parameter has high spectral dimensionality, e.g., a spectral dimensionality of five or more.

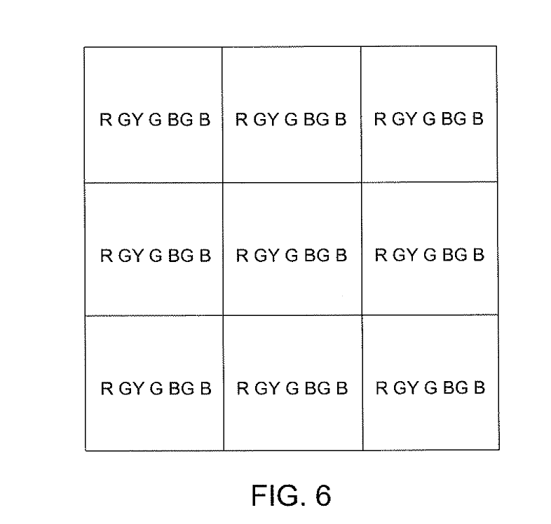

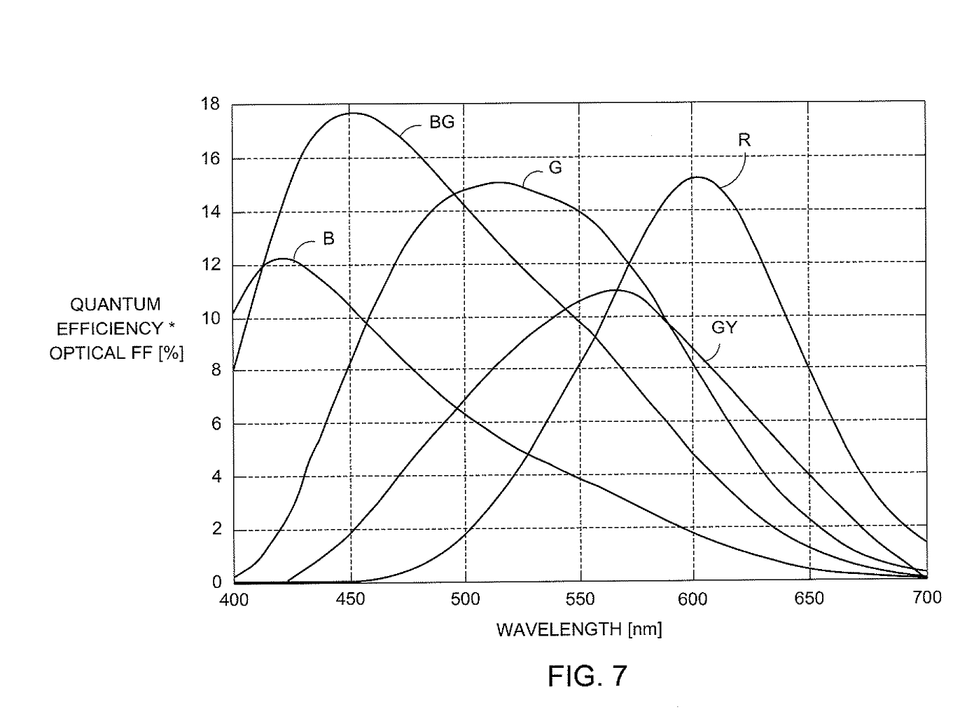

FIG. 6 shows one possible arrangement of pixels in the imaging sensor that is tuned based on the default capture parameter. FIG. 6 is a conceptual illustration of color channels of each pixel in the imaging sensor with tunable color sensitivities. As shown in FIG. 6, each pixel has five channels. In the example embodiment, each pixel has a red-like channel, a green-yellow-like channel, a green-like channel, a blue-green-like channel, and a blue-like channel. Thus, the default capture parameter has a spectral dimensionality of five. The spectral sensitivities of each pixel are shown in FIG. 7. In the example embodiment, and as shown in FIG. 7, the default capture parameter has sensitivities centered in wavelengths which divide the visible spectrum of light with substantially equal levels of sensitivity for each dimension, i.e., each color channel. In other embodiments, each pixel can have color channels having other sensitivities. The depiction of the color channels of the image sensor are for ease of illustration, and is not indicative of actual dimensionalities, sensitivities and number of pixels of the image sensor.

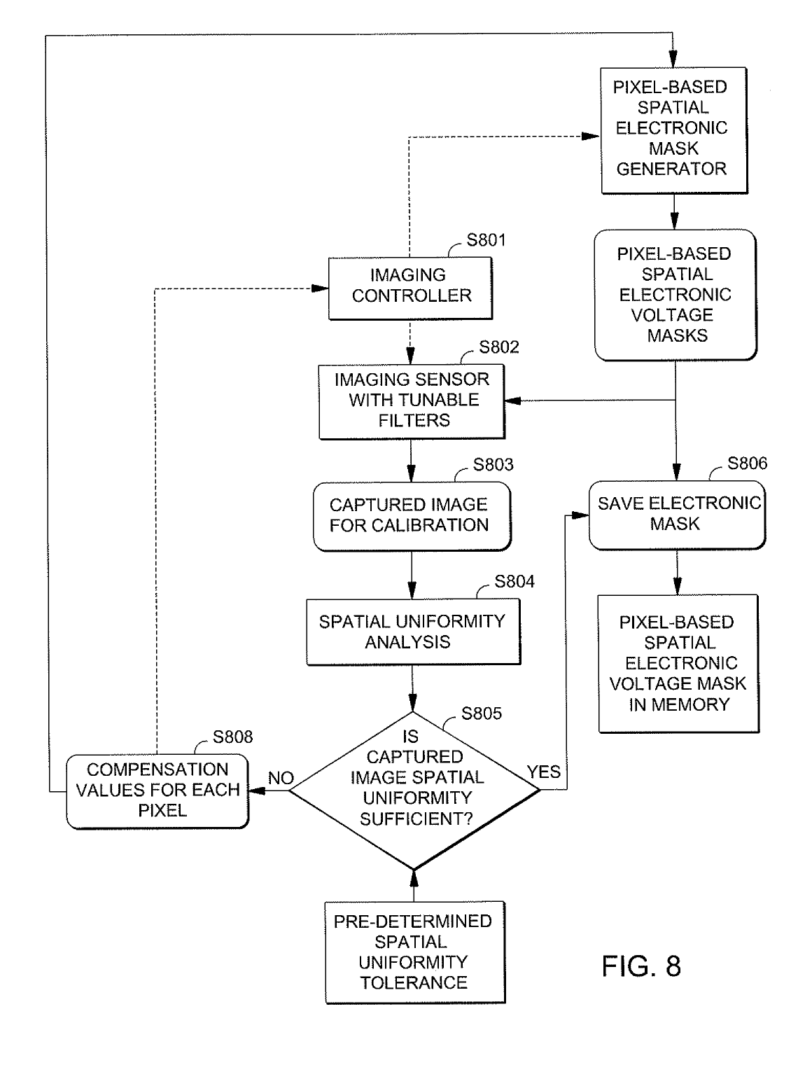

One possible example for selection of an initial state for the electronic mask is shown in FIG. 8, which shows an adaptive method to determine initial state pixel-based spatial electronic voltage mask. In this example, one possible setting is by adjusting the voltage in the initial state to produce uniform neutral response for a perfectly uniform and diffuse grey card under D50 illumination. Note that in actual imaging sensors there are non-uniformities in the response of individual pixels due to manufacturing tolerances and the optics used with the sensor will further produce non-uniformities in color and sensitivity. Therefore the voltage values generated for the pixel-by-pixel basis spatial electronic mask are not the same for all pixels, but they ordinarily have values that produce the same image data under the calibration conditions described above. By providing a system for pixel-by-pixel calibration of a tunable imaging sensor it is possible to: (a) compensate for non-uniformities in sensitivity and spectral response in the sensor due to manufacturing; and (b) compensate for non-uniformities in sensitivity and spectral response due to optical aberrations and distortions.

As shown in FIG. 8, all values of the pixel-based spatial electronic voltage mask are set to same default factory value. In step S801, the imaging controller controls the imaging sensor with tunable filters to an initial state mask and captures a spectral image for calibration (steps S802 and S803). In step S804, spatial uniformity analysis is performed and if in step S805 the captured image spatial uniformity is sufficient according to a pre-determined spatial uniformity tolerance, then in step S806 the pixel-based spatial electronic voltage masks is saved in the memory.

If the spatial uniformity of the captured image for calibration is not within specified tolerance, then in step S808 a compensation value is calculated for each pixel and sent to the pixel-based spatial electronic mask generator that creates a new pixel-based spatial electronic voltage mask. Then, in an iterated repetition of step S801, the imaging controller then sends command to the imaging sensor with tunable filters to captures a new calibration spectral image and the captured spectral image for calibration is analyzed for spatial uniformity. This iterative process is repeated until spatial uniformity of the captured spectral image is within the specified tolerance.

The electronic mask for the initial state can be stored in a memory unit once the imaging system is calibrated and it is used every time the imaging system is turned on. The calibration procedure can be repeated for different lenses and illuminants and the calibration saved in the memory unit.

Returning to FIG. 5, in steps S502 and S503, the image controller sends a command to tune the imaging sensor in accordance with the default capture parameter and capture a spectral image. In the example embodiment, the default capture parameter corresponds to the signals to produce the arrangement of pixels in the imaging sensor shown in FIG. 6, such that the imaging sensor has color channels for five different spectral sensitivities in accordance with FIG. 7, and thus has a spectral dimensionality of five.

In step S504, the scene property analysis module 77 determines whether the captured spectral image is the final image. In the example embodiment, the scene property analysis module 77 determines whether the captured spectral image is the final image based on a user input. For example, if the shutter is half-pressed, then it is determined that the shooting mode is an analysis mode, and if the shutter is full-pressed, then it is determined that the shooting mode is not the analysis mode. If the spectral image was captured in the analyses mode, then it is not the final image.

If the scene property analysis module 77 determines that the captured image is the final image (“YES” in step S504), then the captured spectral image is stored (step S509).

If the scene property analysis module 77 determines that the captured image is not final image (“NO” in step S504), then processing proceeds to step S505. In step S505, the scene property analysis module 77 analyzes the captured spectral image. In particular, the digital signal for each channel in each pixel is analyzed to determine the spectral signature for each pixel. As described above, the imaging sensor is tuned such that each pixel has five channels with sensitivities centered in wavelengths which divide the visible spectrum of light with substantially equal levels of sensitivity for each channel.

In particular, in the example embodiment in which each pixel has five channels, each pixel is integrated to produce five digital signals, one signal for each channel. As described above, each channel is tuned to a spectral band within the visible spectrum. Therefore, the digital signal for each channel corresponds to a respective spectral band within the visible spectrum.

The digital signal for each channel is represented as a digital count level. The range of digital count levels is determined by the imaging sensor. For example, for an imaging sensor with 10-bit acquisition capabilities for each channel, the digital count level would range from 0 units to 1024 units, wherein a channel will have a signal reading of 1024 units when the channel is saturated.

For example, a pixel in a region with an orange color would have a digital signal reading as follows: Blue channel: 40 units; Blue-Green channel: 60 units; Green channel: 250 units; Green-Yellow channel: 850 units; Red channel: 940 units. This reading can be represented in a 5×1 matrix as follows (40, 60, 250, 850, 940).

The digital count level for each channel is converted to a spectral reflectance factor. Thus, the signals produced by each pixel are converted into spectral reflectance factors for each spectral band represented by the pixel, as determined by the tuning parameters for the pixel. This set of five spectral reflectance factors, one for each tuned spectral band, is the spectral signature of the pixel.

For example, if the digital count levels for a pixel in a region convert to spectral reflectance factors R_{B}, R_{BG}, R_{G}, R_{GY} and R_{R} for the Blue, Blue-Green, Green, Green-Yellow, and Red channels (respectively), the spectral signature for the pixel is represented by the 5×1 matrix (R_{B}, R_{BG}, R_{G}, R_{GY}, R_{R}).

In the example embodiment, the spectral signature for each pixel is determined by using a look up table (LUT) of predetermined spectral signatures that maps digital count levels for each channel to a corresponding spectral reflectance. In mapping the digital count levels to spectral reflectance values, a threshold tolerance is applied to accommodate variability of spectral curves in one spectral signature category as well as effects of imaging system noise.

In other embodiments, the spectral signature for each pixel can be estimated by applying a predetermined transformation to the digital count levels for each channel of the pixel.

Contiguous pixels with similar spectral signatures are clustered into regions of the captured scene, wherein each such region shares similar spectral content that is dissimilar from spectral content in other regions of the scene.

For each region, new spectral bands are determined so as to increase spectral differentiation for spectral content in the region. For example, for a region with an dark blue spectral signature, there is not much additional information captured by acquiring the Green-Yellow and Red channels. Therefore, the imaging capturing system with tunable sensitivities is adjusted for the dark blue spectral signature region to increase the sensitivities for the Blue, Blue-Green and Green channels, and by doing so, it is possible to obtain more meaningful spectral selection and to increase signal-to-noise ratio.

The determination of the new spectral bands for each region will now be described in more detail. As described above, the imaging sensor is tuned in accordance with the default capture parameter during capture of the spectral image, and the default capture parameter corresponds to the signals to produce the arrangement of pixels in the imaging sensor shown in FIG. 5. Such an arrangement provides for imaging sensor sensitivities for five spectral bands that substantially equally divide the visible spectrum of light.

Therefore, the captured spectral image provides information for the following five spectral bands that divide the spectra delimited by 400 nm to 700 nm: 400-460 nm, 460-520 nm, 520-580 nm, 580-640 nm, 640-700 nm. The five new spectral bands are determined by weighting each of the spectral bands corresponding to the captured spectral image. The spectral bands are weighted according to the relevance of spectral information in the band.

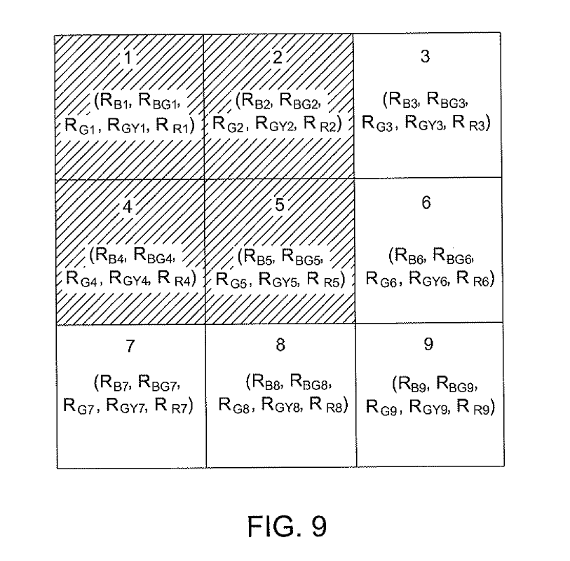

Weighting of the spectral bands will now be described in more detail. FIG. 9 illustrates an example 3×3 pixel group of the captured spectral image. As shown in FIG. 9, contiguous pixels 1, 2, 4 and 5 form a dark blue region in the spectral image. Each pixel in this dark blue region has five channels: Blue, Blue-Green, Green, Green-Yellow, and Red, corresponding to the spectral bands 400-460 nm, 460-520 nm, 520-580 nm, 580-640 nm, 640-700 nm (respectively). In this dark blue region the converted spectral reflectance values for the Blue, Blue-Green, Green, Green-Yellow, and Red channels of Pixel 1 are R_{B1}, R_{BG1}, R_{G1}, R_{GY1}, R_{R1}(respectively). Similarly, the reflectance values for Pixel 2 are R_{B2}, R_{BG2}, R_{G2}, R_{GY2}, R_{R2}, the reflectance values for Pixel 4 are R_{B4}, R_{BG4}, R_{G4}, R_{GY4}, R_{R4}, and the reflectance values for Pixel 5 are R_{B5}, R_{BG5}, R_{G5}, R_{GY5}, R_{R5}.

For each spectral band, the reflectance values are added to produce a weight value. Using the above example, the weight values for each spectral band in the dark blue region are determined as follows:

W_{B}=R_{B1}+R_{B2}+R_{B4}+R_{B5} Equation 1

W_{BG}=R_{BG1}+R_{BG2}+R_{BG4}+R_{BG5} Equation 2

W_{G}=R_{G1}+R_{G2}+R_{G4}+R_{G5} Equation 3

W_{GY}=R_{GY1}+R_{GY2}+R_{GY4}+R_{GY5} Equation 4

W_{R}=R_{R1}+R_{R2}+R_{R4}+R_{R5} Equation 5

These weight values W_{B}, W_{BG}, W_{G}, W_{GY}, and W_{R} denote the weight of information in the respective spectral band. In other words, these weight values are determined so as to increase spectral differentiation for spectral content in the dark blue region defined by contiguous pixels 1, 2, 4 and 5.

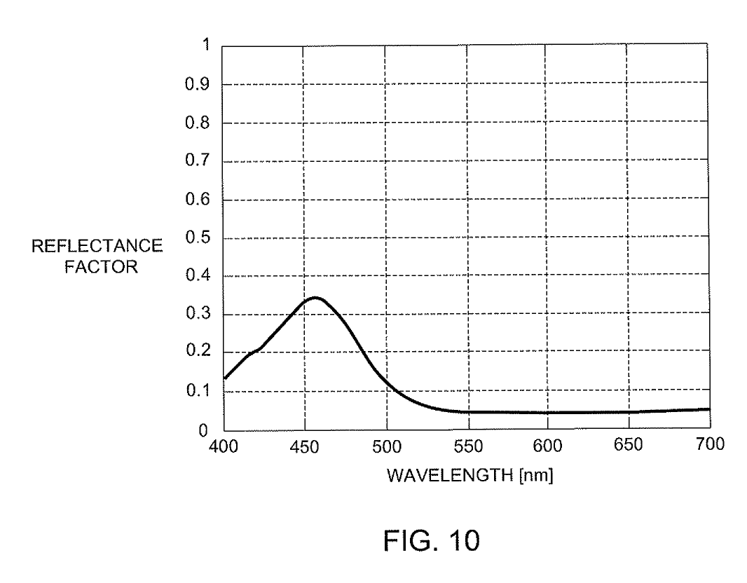

For example, for a region related to a dark blue object having the spectral reflectance as shown in FIG. 10, the largest weight value would correspond to the spectral band from 400-460 nm with much lower weight values for other spectral bands. This would translate to voltage adjustment, as will be described below, that uses mostly the short-spectral channel to capture this data. By doing so the adaptive system increases SNR (signal-to-noise ratio).

Returning to the description of FIG. 5, in step S506, a spectral mask is constructed for application to the imaging sensor. The spectral mask is constructed by using the weight values determined for each of the multiple different regions. In particular, each weight value is converted into a corresponding voltage adjustment to be applied to the pixel-by-pixel basis spatial electronic voltage mask. Continuing with the preceding example related to FIG. 9, weight values W_{B}, W_{BG}, W_{G}, W_{GY}, and W_{R} are converted into voltage adjustments to be applied to the portions of the electronic voltage mask corresponding to the Blue, Blue-Green, Green, Green-Yellow, and Red channels (respectively) of Pixels 1, 2, 4 and 5. In the example embodiment, the weight values are converted into voltage adjustments by using a pre-calculated LUT which maps weight values to voltage adjustments. In other embodiments, the weight values are converted into voltage adjustments by applying a transformation which transforms weight values to voltage adjustments.

In step S507, the voltage adjustments for each region are provided to the electronic mask generator for determination of a revised spatial mask.

In steps S508 and S502, the image controller sends a command to tune the imaging sensor in accordance with the revised spatial mask. As described above, in step S504, the scene property analysis module 77 determines whether the captured spectral image is the final image, and if the scene property analysis module 77 determines that the captured image is the final image (“YES” in step S504), then the captured spectral image is stored (step S509).

Thus, the present disclosure contemplates apparatus and methods for adaptive imaging to perform adjustments of spectral selectivity on a pixel-by-pixel basis for imaging sensors with tunable spectral properties. As seen herein, there are in combination an imaging sensor with tunable spectral responsivities, an imaging controller that controls the imaging sensor and also a spatial pixel-by-pixel basis electronic mask generation unit that generates pixel-based spatial electronic masks to control the shape of the sensitivity curves of the imaging sensor with tunable spectral responsivities, a scene property analysis module that analyzes the properties of scene based on images captured by the imaging sensor with tunable spectral responsivities using electronic control signals generated by the electronic mask generation unit, and a module generates a revised spatial mask from the results of the scene analysis or to render the final image. One such imaging sensor may be a transverse field detector (TFD) sensor, and the imaging sensor may capture multiple images.

Also contemplated herein are iterative methods and apparatus for spatial non-uniformity correction based on an imaging sensor with tunable spectral responsivities, comprising an imaging sensor with tunable spectral responsivities, an initial state for the pixel-based spatial electronic mask, an imaging control that captures an image with initial state pixel-based spatial electronic mask, a scene analysis module that analysis spatial uniformity of captured image, and a decision module that decides if the spatial uniformity is within pre-established tolerances or not. If the criteria of spatial uniformity are met the final pixel-based electronic spatial mask is saved in a memory unit. If the criteria are not met the method goes to the next iteration by generating appropriate spatial compensation for the spatial non-uniformity in light sensitivity and color and appropriate pixel-basis spatial electronic masks are generated for the subsequent image capture.

Other examples may be developed in accordance with the description herein for use of an imaging assembly which has a spectral response which is tunable in accordance with a capture parameter, such as an imaging assembly with an image sensor which has a tunable spectral response or an imaging assembly with an image sensor and a preceding color filter array which has a tunable spectral response.

In the embodiments described herein, the tunable imaging assembly may tunable such that each pixel or each region of multiple pixels is tunable individually, such that the spectral responsivity of each pixel or region of pixels is tunable independently of the spectral responsivity of other pixels or regions of pixels. In some example embodiments, the entirety of the imaging assembly may be tuned to the same spectral responsivity, such that substantially all pixels and substantially all regions of pixels are tuned to substantially the same spectral responsivity.

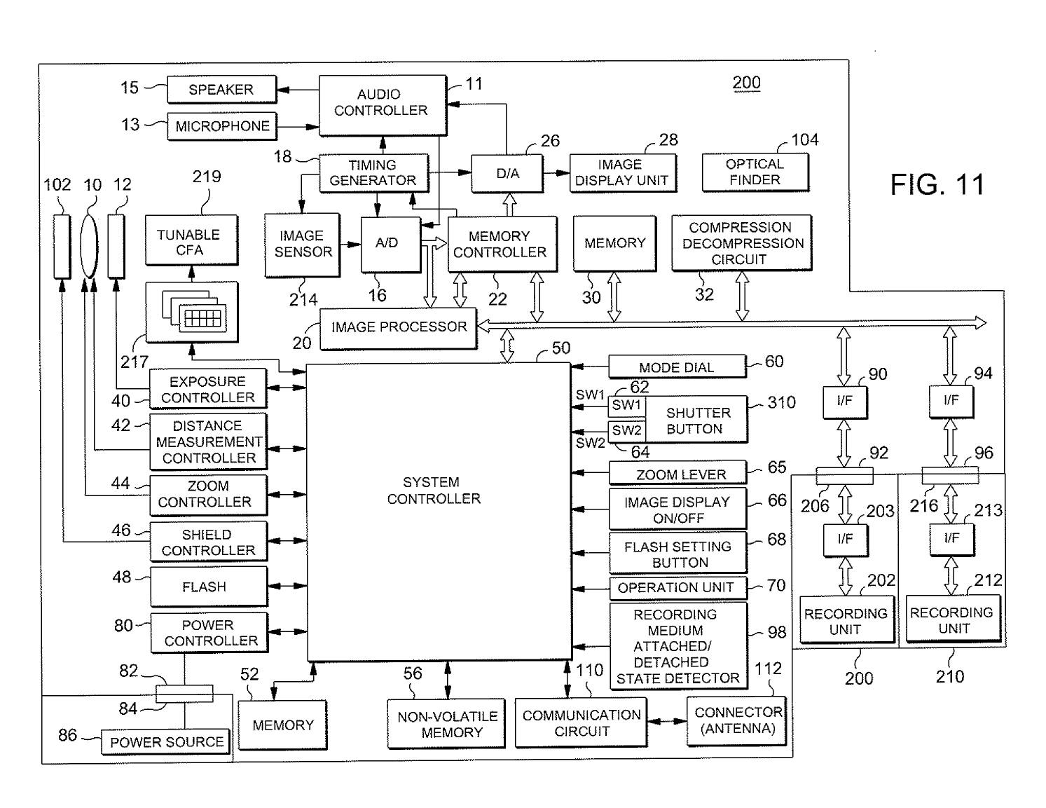

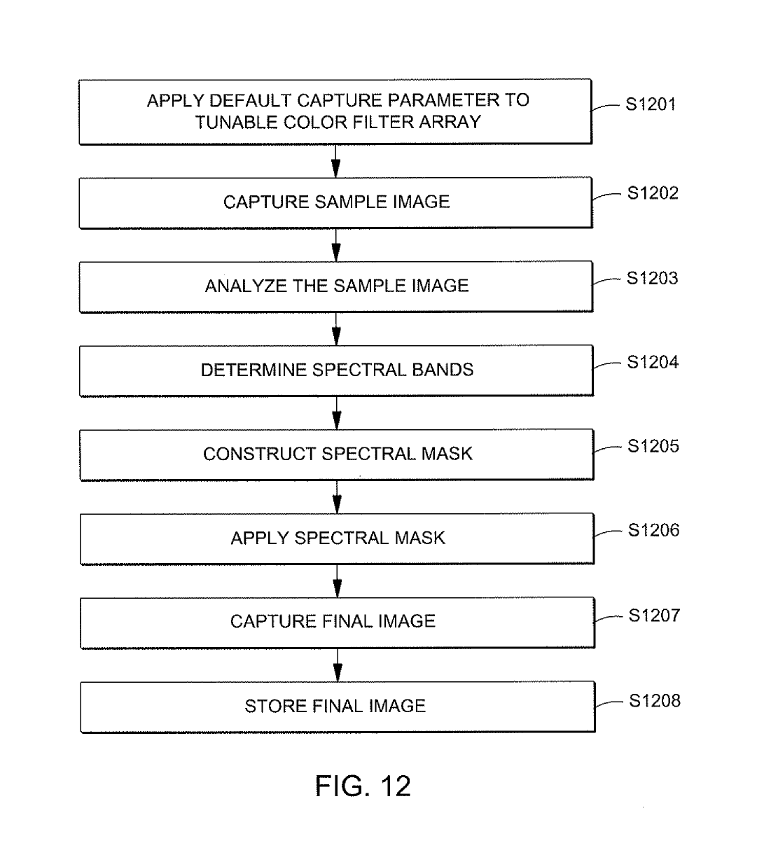

### <FIGS. 11 and 12>

FIG. 11 is a block diagram showing another example embodiment of an arrangement of a digital camera 200. In the embodiment of FIG. 11, parts and features that are largely similar to those of the example embodiment of FIG. 2 are illustrated with like reference numerals, and a detailed explanation thereof is omitted in the interest of brevity.

One way that the embodiment of FIG. 11 differs from the embodiment of FIG. 2 concerns the construction of the tunable imaging assembly. In the embodiment of FIG. 2, the tunable imaging assembly includes tunable image sensor 14, perhaps in combination with optics such as lens 10. Because the image sensor 14 in the embodiment of FIG. 2 itself has a tunable spectral response, it is customary to omit a preceding color filter array, since the inclusion of any filter necessarily would decrease the signal-to-noise ratio by filtering the amount of light incident on image sensor 14.

In contrast, in the embodiment of FIG. 11, the spectral responsivity of image sensor 214 is not necessarily tunable, but rather the spectral responsivity of a preceding color filter array 219 is. Thus, in the example embodiment of FIG. 11, the tunable imaging assembly includes tunable color filter array (CFA) 219 and image sensor 214, perhaps in combination with optics such as lens 10. In the embodiment of FIG. 11, image sensor 214 is not necessarily tunable, although in other embodiments it might be.

Turning more specifically to the embodiment of FIG. 11, a light beam (light beam incident upon the angle of view of the lens) from an object in a scene that goes through the optical system (image sensing lens) 10 passes through an opening of a shutter 12 having a diaphragm function, is filtered by tunable color filter array 219, and forms an optical image of the object on the image sensing surface of image sensor 214. The image sensor 214 converts the optical image to analog image signals and outputs the signals to an A/D converter 16. The A/D converter 16 converts the analog image signal to digital image signals (image data).

In FIG. 11, an imaging assembly is comprised of tunable color filter array 219 and image sensor 214 together with associated optics, such that in some embodiments the imaging assembly is comprised of image sensor 214 preceded by color filter array 219 and lens 10.

Tunable color filter array 219 may be a spatial color filter array, such as a color filter array having a spatial distribution of a repeating pattern of filter elements. In this case, image data output from image sensor 214 is demosaiced, so as to result in output of a red-like channel for each pixel, a green-yellow-like channel for each pixel, a green-like channel for each pixel, a blue-green-like channel for each pixel, and a blue-like channel for each pixel. Alternatively, tunable color filter array 219 might be a temporal color filter array, in which case the color filter quickly and sequentially changes spectral responsivity, with image data collected by image sensor 214 after each change. In this case, the sequential outputs of image sensor 214 are collected so as to result in output signals for each pixel for a red-like channel, a green-yellow-like channel, a green-like channel, a blue-green-like channel, and a blue-like channel.

The spectral responsivity of tunable color filter array 219 is tunable in accordance with a capture parameter 217. In this embodiment, capture parameter 217 may be comprised of multiple spatial masks, with one mask for each channel of information output by image sensor 214, namely, the aforementioned red-like channel, green-yellow-like channel, green-like channel, blue-green-like channel, and blue-like channel. Thus, in this example where image sensor 214 outputs three or more channels, capture parameters 217 include a spatial mask DR for the red-like channel of information, a spatial mask DGY for the green-yellow-like channel of information, a spatial mask DG for the green-like channel of information, a spatial mask DBG for the blue-green-like channel of information, and a spatial mask DB for the blue-light channel of information. Each spatial mask comprises an array of control parameters applied to the tunable color filter array 219 in correspondence to pixels or regions of pixels in image sensor 214. The resulting spectral responsivity of each pixel, or each region of plural pixels, is thus tunable individually and independently of other pixels or regions of pixels, by virtue of the capture parameter 217 imposed on tunable color filter array 219.

Tunable color filter array 219 may be comprised of a tunable color filter array as described in U.S. Pat. No. 6,466,961 by Miller, mentioned hereinabove. Spatial masks DR, DGY, DG, DBG and DB may correspond to voltage biases applied to control electrodes of the tunable color filter array 219.

FIG. 12 is a flow diagram for explaining operation of this example embodiment. The process steps shown in FIG. 12 are computer-executable process steps executed primarily by system controller 50 based on computer-executable process steps stored in a computer-readable memory medium such as non-volatile memory 56.

Briefly, according to FIG. 12, a default capture parameter is applied to the imaging assembly. The default capture parameter has high spectral dimensionality. A sample image of a scene is captured and the sample image is analyzed to identify multiple different regions in the scene. Each such region shares similar spectral content that is dissimilar from spectral content in other regions of the scene. Spectral bands for each region of the multiple different regions are determined. The spectral bands are determined so as to increase spectral differentiation for spectral content in each such region. A spectral mask is constructed for application to the imaging assembly. The spectral mask is constructed from the spectral bands for the multiple different regions. The spectral mask is applied as the capture parameter to the imaging assembly, and a spectral image of the scene is captured and stored.

In more detail, in step S1201, a default capture parameter is applied to tunable color filter array 219. The default capture parameter may be a pre-designated capture parameter stored in non-volatile memory 56. In this example embodiment, the capture parameter may be a spatial mask which individually tunes each pixel or each region of plural pixels in tunable color filter array 219, such as by application of spatial masks DR, DGY, DG, DBG and DB.

Following application of the default capture parameter to tunable color filter array 219, a sample spectral image is captured in step S1202. In step S1203, the captured spectral image is analyzed to identify multiple different regions in the scene, wherein each such region shares similar spectral content that is dissimilar from spectral content in other regions of the scene.

After capture of the sample image, step S1204 determines spectral bands for each region. The spectral bands are determined so as to increase spectral differentiation for spectral content in each region.

Step S1205 constructs a spectral mask for application to the imaging assembly. The spectral mask is constructed from the spectral bands for the multiple different regions.

Step S1206 applies the spectral mask to the tunable color filter array 219. Step S1207 captures a final spectral image of the scene and the final image is stored in step S1208.

In the embodiments described herein, the tunable color filter array may tunable such that each pixel or each region of multiple pixels is tunable individually, such that the spectral responsivity of each pixel or region of pixels is tunable independently of the spectral responsivity of other pixels or regions of pixels. In some example embodiments, the entirety of the color filter array may be tuned to the same spectral responsivity, such that substantially all pixels and substantially all regions of pixels are tuned to substantially the same spectral responsivity.

### Other Embodiments

According to other embodiments contemplated by the present disclosure, example embodiments may include a computer processor such as a single core or multi-core central processing unit (CPU) or micro-processing unit (MPU), which is constructed to realize the functionality described above. The computer processor might be incorporated in a stand-alone apparatus or in a multi-component apparatus, or might comprise multiple computer processors which are constructed to work together to realize such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. For these purposes, access to the non-transitory computer-readable storage medium may be a local access such as by access via a local memory bus structure, or may be a remote access such as by access via a wired or wireless network or Internet. The computer processor(s) may thereafter be operated to execute the computer-executable program or program steps to perform functions of the above-described embodiments.

According to still further embodiments contemplated by the present disclosure, example embodiments may include methods in which the functionality described above is performed by a computer processor such as a single core or multi-core central processing unit (CPU) or micro-processing unit (MPU). As explained above, the computer processor might be incorporated in a stand-alone apparatus or in a multi-component apparatus, or might comprise multiple computer processors which work together to perform such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. Access to the non-transitory computer-readable storage medium may form part of the method of the embodiment. For these purposes, access to the non-transitory computer-readable storage medium may be a local access such as by access via a local memory bus structure, or may be a remote access such as by access via a wired or wireless network or Internet. The computer processor(s) is/are thereafter operated to execute the computer-executable program or program steps to perform functions of the above-described embodiments.

The non-transitory computer-readable storage medium on which a computer-executable program or program steps are stored may be any of a wide variety of tangible storage devices which are constructed to retrievably store data, including, for example, any of a flexible disk (floppy disk), a hard disk, an optical disk, a magneto-optical disk, a compact disc (CD), a digital versatile disc (DVD), micro-drive, a read only memory (ROM), random access memory (RAM), erasable programmable read only memory (EPROM), electrically erasable programmable read only memory (EEPROM), dynamic random access memory (DRAM), video RAM (VRAM), a magnetic tape or card, optical card, nanosystem, molecular memory integrated circuit, redundant array of independent disks (RAID), a nonvolatile memory card, a flash memory device, a storage of distributed computing systems and the like. The storage medium may be a function expansion unit removably inserted in and/or remotely accessed by the apparatus or system for use with the computer processor(s).

This disclosure has provided a detailed description with respect to particular representative embodiments. It is understood that the scope of the appended claims is not limited to the above-described embodiments and that various changes and modifications may be made without departing from the scope of the claims.

What is claimed is:

1. A method for adaptive spectral image capture using an image capture device which includes an imaging assembly having a spectral response which is tunable in accordance with a capture parameter, the method comprising:
applying a default capture parameter to the imaging assembly, wherein the default capture parameter has high spectral dimensionality;
capturing a sample image of a scene;
analyzing the sample image to identify multiple different regions in the scene, wherein each such region shares similar spectral content that is dissimilar from spectral content in other regions of the scene;
determining spectral bands for each region of the multiple different regions, wherein the spectral bands are determined so as to increase spectral differentiation for spectral content in each such region;
constructing a spectral mask for application to the imaging assembly, wherein the spectral mask is constructed from the spectral bands for the multiple different regions;
applying the spectral mask as the capture parameter to the imaging assembly; and
capturing and storing a spectral image of the scene.

2. The method according to claim 1, wherein the default capture parameter has spectral dimensionality of five or more.

3. The method according to claim 1, wherein the default capture parameter has sensitivities centered in wavelengths which divide the visible spectrum of light with substantially equal levels of sensitivity for each dimension.

4. The method according to claim 3, wherein the default capture parameter has spectral dimensionality of five (5) with sensitivities centered in wavelengths which divide the visible spectrum of light with substantially equal levels of sensitivity each dimension.

5. The method according to claim 1, wherein in each region, the spectral mask has a spectral dimensionality equal to that of the default capture parameter.

6. The method according to claim 1, wherein in each region, the spectral mask has a spectral dimensionality different from that of the default capture parameter.

7. The method according to claim 1, wherein the analyzing step comprises:
accessing a look-up table (LUT) which maps between spectral signature categories and the high spectral dimensionality of the default capture parameter;
for each pixel of the imaging assembly, using the LUT to map from the high spectral dimensionality of the default capture parameter to a corresponding spectral signature category, wherein a threshold tolerance is applied to accommodate variability of spectral curves in one spectral signature category as well as effects of imaging system noise; and
clustering contiguous pixels with similar spectral signature categories into the same region.

8. The method according to claim 1, wherein the imaging assembly comprises an image sensor which has a tunable spectral response.

9. A module for image capture using an image capture device which includes an imaging assembly having a spectral response which is tunable in accordance with a capture parameter, the module comprising:
a capture parameter module constructed to apply a default capture parameter to the imaging assembly, wherein the default capture parameter has high spectral dimensionality;
an imaging controller module constructed to capture a sample image of a scene;
a scene property analysis module constructed to analyze the sample image to identify multiple different regions in the scene, wherein each such region shares similar spectral content that is dissimilar from spectral content in other regions of the scene;
a band determining module constructed to determine spectral bands for each region of the multiple different regions, wherein the spectral bands are determined so as to increase spectral differentiation for spectral content in each such region;
a spatial mask generation module constructed to construct a spectral mask for application to the imaging assembly, wherein the spectral mask is constructed from the spectral bands for the multiple different regions,
wherein the spectral mask is applied as the capture parameter to the imaging assembly, the imaging controller module captures a final image of the scene after the spectral mask is applied as the capture parameter, and the final image is stored.

10. The module according to claim 9, wherein the default capture parameter has spectral dimensionality of five or more.

11. The module according to claim 9, wherein the default capture parameter has sensitivities centered in wavelengths which divide the visible spectrum of light with substantially equal levels of sensitivity for each dimension.

12. The module according to claim 11, wherein the default capture parameter has spectral dimensionality of five (5) with sensitivities centered in wavelengths which divide the visible spectrum of light with substantially equal levels of sensitivity each dimension.

13. The module according to claim 9, wherein in each region, the spectral mask has a spectral dimensionality equal to that of the default capture parameter.

14. The module according to claim 9, wherein in each region, the spectral mask has a spectral dimensionality different from that of the default capture parameter.

15. The module according to claim 9, wherein the analyzing step comprises:
accessing a look-up table (LUT) which maps between spectral signature categories and the high spectral dimensionality of the default capture parameter;
for each pixel of the imaging assembly, using the LUT to map from the high spectral dimensionality of the default capture parameter to a corresponding spectral signature category, wherein a threshold tolerance is applied to accommodate variability of spectral curves in one spectral signature category as well as effects of imaging system noise; and
clustering contiguous pixels with similar spectral signature categories into the same region.

16. The module according to claim 9, wherein the imaging assembly comprises an image sensor which has a tunable spectral response.

17. An image capture device which includes an imaging assembly having a spectral response which is tunable in accordance with a capture parameter, the apparatus comprising:
a capture parameter unit constructed to apply a default capture parameter to the imaging assembly, wherein the default capture parameter has high spectral dimensionality;
an imaging controller constructed to capture a sample image of a scene;
a scene property analysis unit constructed to analyze the sample image to identify multiple different regions in the scene, wherein each such region shares similar spectral content that is dissimilar from spectral content in other regions of the scene;
a band determining unit constructed to determine spectral bands for each region of the multiple different regions, wherein the spectral bands are determined so as to increase spectral differentiation for spectral content in each such region;
a spatial mask generation unit constructed to construct a spectral mask for application to the imaging assembly, wherein the spectral mask is constructed from the spectral bands for the multiple different regions,
wherein the spectral mask is applied as the capture parameter to the imaging assembly, the imaging controller captures a final image of the scene after the spectral mask is applied as the capture parameter, and the final image is stored.

18. The image capture device according to claim 17, wherein the default capture parameter has spectral dimensionality of five or more.

19. The image capture device according to claim 17, wherein the default capture parameter has sensitivities centered in wavelengths which divide the visible spectrum of light with substantially equal levels of sensitivity for each dimension.

20. The image capture device according to claim 19, wherein the default capture parameter has spectral dimensionality of five (5) with sensitivities centered in wavelengths which divide the visible spectrum of light with substantially equal levels of sensitivity each dimension.

21. The image capture device according to claim 17, wherein in each region, the spectral mask has a spectral dimensionality equal to that of the default capture parameter.

22. The image capture device according to claim 17, wherein in each region, the spectral mask has a spectral dimensionality different from that of the default capture parameter.

23. The image capture device according to claim 17, wherein the analyzing step comprises:
accessing a look-up table (LUT) which maps between spectral signature categories and the high spectral dimensionality of the default capture parameter;
for each pixel of the imaging assembly, using the LUT to map from the high spectral dimensionality of the default capture parameter to a corresponding spectral signature category, wherein a threshold tolerance is applied to accommodate variability of spectral curves in one spectral signature category as well as effects of imaging system noise; and
clustering contiguous pixels with similar spectral signature categories into the same region.

24. The image capture device according to claim 17, wherein the imaging assembly comprises an image sensor which has a tunable spectral response.

25. A computer-readable storage medium on which is retrievably stored computer-executable process steps for image capture using an image capture device which includes an imaging assembly having a spectral response which is tunable in accordance with a capture parameter, the process steps comprising:
applying a default capture parameter to the imaging assembly, wherein the default capture parameter has high spectral dimensionality;
capturing a sample image of a scene;
analyzing the sample image to identify multiple different regions in the scene, wherein each such region shares similar spectral content that is dissimilar from spectral content in other regions of the scene;
determining spectral bands for each region of the multiple different regions, wherein the spectral bands are determined so as to increase spectral differentiation for spectral content in each such region;
constructing a spectral mask for application to the imaging assembly, wherein the spectral mask is constructed from the spectral bands for the multiple different regions;
applying the spectral mask as the capture parameter to the imaging assembly; and
capturing and storing a spectral image of the scene.

26. The computer-readable storage medium according to claim 25, wherein the default capture parameter has spectral dimensionality of five or more.

27. The computer-readable storage medium according to claim 25, wherein the default capture parameter has sensitivities centered in wavelengths which divide the visible spectrum of light with substantially equal levels of sensitivity for each dimension.

28. The computer-readable storage medium according to claim 27, wherein the default capture parameter has spectral dimensionality of five (5) with sensitivities centered in wavelengths which divide the visible spectrum of light with substantially equal levels of sensitivity each dimension.

29. The computer-readable storage medium according to claim 25, wherein in each region, the spectral mask has a spectral dimensionality equal to that of the default capture parameter.

30. The computer-readable storage medium according to claim 25, wherein in each region, the spectral mask has a spectral dimensionality different from that of the default capture parameter.

31. The computer-readable storage medium according to claim 25, wherein the analyzing step comprises:
accessing a look-up table (LUT) which maps between spectral signature categories and the high spectral dimensionality of the default capture parameter;
for each pixel of the imaging assembly, using the LUT to map from the high spectral dimensionality of the default capture parameter to a corresponding spectral signature category, wherein a threshold tolerance is applied to accommodate variability of spectral curves in one spectral signature category as well as effects of imaging system noise; and
clustering contiguous pixels with similar spectral signature categories into the same region.

32. The computer-readable storage medium according to claim 25, wherein the imaging assembly comprises an image sensor which has a tunable spectral response.
